(19) United States
(12) Patent Application Publication
(10) Pub. No.: US 2004/0204980 A1
(43) Pub. Date: Oct. 14, 2004

(54) Assessment of opportunities to use innovation to stimulate business growth

(76) Inventors: Daniel I. Swedberg, Haymarket, VA (US); Joseph P. Coyle JR., Marlton, NJ (US); Charnell T. Havens, McKinney, TX (US); David R. Townsend, Bloomfield Hills, MI (US); Anthony D. Sullivan, Richardson, TX (US); Melinda K. Lockhart, Allen, TX (US)

Correspondence Address: David G. Wille, Esq., Baker & Botts, L.L.P., Suite 600, 2001 Ross Avenue, Dallas, TX, 75201-2980, US

(21) Appl. No.: 10/412,662

(22) Filed: Apr. 11, 2003

(51) Int. Cl. G06F 17/60

(52) U.S. Cl. 705/10

(57) ABSTRACT

A method includes: obtaining answers to a plurality of predetermined questions from at least one person, the questions relating to a situation in which an enterprise provides a client with offerings that include at least one of a product and a service; and utilizing the answers to at least some of the questions to prepare a report, including identifying within the report areas of past innovation within the enterprise with respect to the offerings, and areas currently appropriate for innovation within the enterprise with respect to the offerings. The method can be implemented in the form of a computer program stored on a computer-readable medium.

### TECHNICAL FIELD OF THE INVENTION

This invention relates in general to techniques for improving business relationships and, more particularly, to techniques for stimulating growth in business relationships.

### BACKGROUND OF THE INVENTION

There are a variety of situations in which it is desirable to stimulate business growth. One example is a situation in which a business enterprise provides offerings such as products or services to a client. A certain degree of growth may occur naturally, but it is possible to facilitate growth through appropriate planning. Some tools and methods have previously been developed to support growth planning, and have been generally adequate for their intended purposes, but they have not been satisfactory in all respects. For example, they typically seek to align existing business offerings and capabilities with defined needs of clients, such that business growth (if any) is driven by client-defined needs and enterprise capabilities. Stated differently, existing techniques tend to emphasize market-driven strategies for business growth, rather than proactive market-driving strategies. Consequently, existing techniques do not always lead to optimum.

### SUMMARY OF THE INVENTION

From the foregoing, it may be appreciated that a need has arisen for a technique for stimulating business growth which is more effective than known approaches. One form of the invention involves a method which includes: obtaining answers to a plurality of predetermined questions from at least one person, the questions relating to a situation involving a specified client and a specified enterprise, the enterprise providing the client with offerings that include at least one of a product and a service; and utilizing the answers to at least some of the questions to prepare a report, including identifying within the report areas of past innovation within the enterprise with respect to the offerings provided to the client, and areas currently appropriate for innovation within the enterprise with respect to the offerings provided to the client.

A different form of the invention involves a computer-readable medium encoded with a computer program which is operable when executed to obtain answers to a plurality of predetermined questions from at least one person, the questions relating to a situation involving a specified client and a specified enterprise, the enterprise providing the client with offerings that include at least one of a product and a service; and to utilize the answers to at least some of the questions to prepare a report, including identifying within the report areas of past innovation within the enterprise with respect to the offerings provided to the client, and areas currently appropriate for innovation within the enterprise with respect to the offerings provided to the client.

### BRIEF DESCRIPTION OF THE DRAWINGS

A better understanding of the present invention will be realized from the detailed description which follows, taken in conjunction with the accompanying drawings, in which:

FIG. 1 is a block diagram of an apparatus in the form of a computer system which is used to carry out techniques that embody aspects of the present invention;

FIG. 2 is a block diagram showing a business relationship to which the techniques implemented by the system of FIG. 1 can be applied, including a business enterprise, a client of the enterprise, customers of the client, and a portion of the enterprise which is responsible for the client;

FIG. 3 is a flowchart showing a procedure which is implemented by the system of FIG. 1 and which is used to assess and identify innovation opportunities that are likely to stimulate business growth in the relationship between the enterprise and client of FIG. 2;

FIGS. 4 through 14 each depict a respective diagram which is generated by the procedure of FIG. 3;

FIG. 15 is a table showing weights assigned to various questions of a survey used in the procedure of FIG. 3, for a set of predetermined categories;

FIG. 16 is a table similar to FIG. 15, but showing several types of totals derived using the information in FIG. 15;

FIG. 17 is a table similar to FIG. 15, showing weights assigned to various questions of the survey used in the procedure of FIG. 3, but for a different set of predetermined categories;

FIG. 18 is a table similar to FIG. 17, but showing several types of totals derived using the information in FIG. 17; and

FIG. 19 is a table showing growth and innovation with respect to three time categories, which are the past, the present and the future.

### DETAILED DESCRIPTION

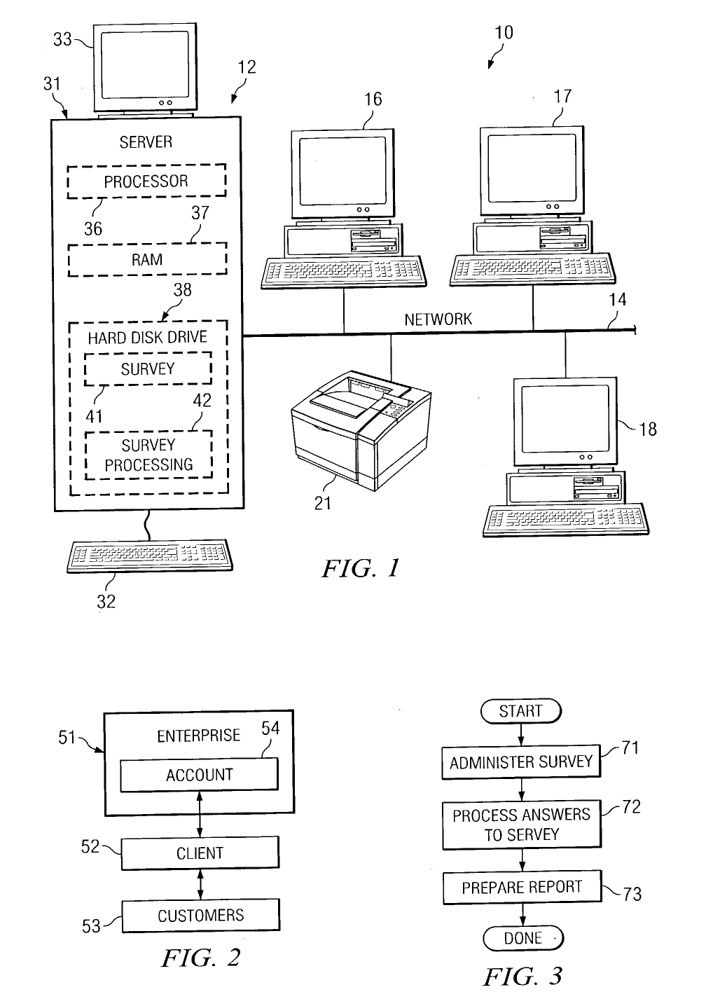

FIG. 1 is a block diagram of an apparatus in the form of a computer system 10, which is used to carry out techniques that embody aspects of the present invention. The computer system 10 includes a network server 12 coupled through a network 14 to a plurality of workstations 16-18, and to a printer 21. Although FIG. 1 shows one server 12, three workstations 16-18, and one printer 21, this configuration is exemplary, and a wide variety of changes could be made to the system 10 without departing from the present invention.

In the disclosed embodiment, the hardware of the network server 12 is a device that can be obtained commercially, for example from Dell Computer Corporation of Austin, Tex. However, a variety of other existing and custom computer hardware systems could alternatively be used for the server 12. The disclosed server 12 includes a system unit 31, a keyboard 32, and a display 33. The keyboard 32 permits a user to input information into the server 12. The keyboard 32 could be replaced by or supplemented with some other type of input device, such as a pointing device of the type commonly known as a mouse or a trackball. The display 33 is a cathode ray tube (CRT) display, but could alternatively be some other type of display, such as a liquid crystal display (LCD). The display 33 serves as an output device, which permits software to present information in a visible form that can be viewed by a user.

The system unit 31 of the server 12 includes a processor 36 of a known type, for example a processor of the type which can be obtained under the trademark PENTIUM from Intel Corporation of Santa Clara, Calif. However, it would alternatively be possible for the processor 36 to be any other suitable type of processor. The system unit 31 also includes some random access memory (RAM) 37, which the processor can use to store a computer program that it is executing, and/or to store data being processed by a program. The system unit 31 also includes a hard disk drive (HDD) 38, which is a device of a known type, and which can store data and/or executable programs. In the disclosed embodiment, the information stored in the HDD 38 includes a survey 41 and a survey processing program 42, each of which will be discussed in more detail later.

The network 14 may be any of a variety of different types of networks, including an intranet, the Internet, a local area network (LAN), a wide area network (WAN), some other type of existing or future network, or a combination of one or more of these types of networks. In the disclosed embodiment, workstations 16-18 are each a system of the type commonly known as a personal computer, and are implemented with personal computers obtained from Dell Computer Corporation of Austin, Tex. However, the workstations 16-18 could alternatively implemented with some other suitable type of computer. The printer 21 in the disclosed embodiment is a network printer of a known type that is commonly referred to as a laser printer, but could alternatively be some other suitable type of printer.

FIG. 2 is a block diagram showing a business enterprise 51 which has a client 52, and the client 52 may in turn have its own customers 53. The enterprise 51 provides offerings to the client 52, for example in the form of products and/or services. For purposes of the following discussion, it is assumed that the enterprise 51 is an information technology (IT) provider, which supplies IT services and/or products to the client 52. However, the enterprise could alternatively be virtually any other type of business enterprise. The enterprise 51 includes an account 54, which is a portion of the enterprise 51 that has primary responsibility for the particular client 52.

It is beneficial for both the enterprise 51 and the client 52 if their business relationship grows over time, especially in regard to the fact that the world economy is progressively becoming a more information-based “digital economy”, as evidenced by the progressively increasing use of the Internet throughout the business world. One important stimulus for business growth is innovation, and a feature of the present invention is the provision of a tool that assists in assessing and identifying opportunities to stimulate business growth through innovation.

In this regard, the survey 41 of FIG. 1 is a set of questions that have been developed specifically to help assess and identify opportunities for innovation that will facilitate growth, in the specific context of an enterprise/client relationship such as that shown in FIG. 2. The survey 41 in the disclosed embodiment uses a predetermined set of 125 questions, which are set forth in the middle column of TABLE 1. The set of 125 questions in TABLE 1 is exemplary. It will be recognized that a larger or smaller number of questions could be used, and that some or all of the questions could be replaced with other questions.

TABLE 1
SURVEY QUESTIONS AND SAMPLE SCORES

| | | SAMPLE |
|---|---|---|
| QUESTIONS | | SCORE |
| SECTION A - ACCOUNT GROWTH HISTORY | | — |
| 1 | The account has been successful in | 3.93 |
| | eliminating or neutralizing competitors for | |
| | this client's business. | |
| 2 | The account has a robust perspective on how | 3.99 |
| | the client's industry should be different in | |
| | the future. | |
| 3 | The account monitors competitors' strategy | 3.45 |
| | for and activity with the client. | |
| 4 | The account monitors competitors' strategy | 3.58 |
| | for and activity with the client's industry. | |
| 5 | The account has extended its reach to | 4.58 |
| | service new users in the client | |
| | organization. | |
| 6 | The account has extended its reach to enable | 4.57 |
| | increased usage of enterprise products and | |
| | services in the client organization. | |
| 7 | The account has identified new or | 4.47 |
| | alternative client uses for enterprise | |
| | products and services. | |
| 8 | The account has provided products and | 5.09 |
| | services to support the client's movement or | |
| | expansion into new geographic areas. | |
| 9 | The account has effectively supported the | 4.90 |
| | demographic expansion of the client's | |
| | business. | |
| 10 | The account has been able to upgrade and | 3.97 |
| | replace existing products and services | |
| | without compromising enterprise revenue and | |
| | profit streams. | |
| 11 | The account has effectively upgraded | 4.90 |
| | existing client solutions using new | |
| | technologies. | |
| 12 | The account has effectively deployed new | 4.96 |
| | products and services. | |
| 13 | The enterprise provides a much broader range | 4.68 |
| | of products and services to this client than | |
| | it provided three (or five) years ago. | |
| 14 | The types of contracts are very different | 4.08 |
| | from those of three years ago. | |
| 15 | This account's pricing strategies are very | 3.71 |
| | different from those of three years ago. | |
| 16 | The client has a history of consistently | 4.48 |
| | renewing contracts with us. | |
| 17 | Products and services provided by the | 4.44 |
| | enterprise three years ago are now being | |
| | provided in greater volume. | |
| 18 | The enterprise brings leading-edge | 4.35 |
| | technology solutions to the client. | |
| 19 | The client prefers that the technologies | 4.89 |
| | provided by the enterprise are tried and | |
| | true. | |
| 20 | Enterprise business from this client always | 3.44 |
| | exceeds the growth rate of corresponding | |
| | industry segment(s). | |
| 21 | This is high margin business. | 3.07 |
| 22 | The margins have increased every year during | 3.08 |
| | the last three years. | |
| 23 | Competitors have taken away part of the | 4.39 |
| | business the enterprise had anticipated | |
| | getting. | |
| 24 | The client has experienced budget cuts that | 5.50 |
| | impact its ability to buy from the | |
| | enterprise. | |
| 25 | The client views enterprise products and | 4.43 |
| | services as productivity enhancers. | |
| 26 | The client views enterprise products and | 4.39 |
| | services as business repositioning enablers | |
| | for them. | |
| — | Enterprise revenue could have been notably | — |
| | higher if the enterprise had more effective | |
| | or efficient: | |
| 27 | A. Capability to anticipate and respond | 5.81 |
| | to client needs | |
| 28 | B. Skill sets | 5.25 |
| 29 | C. Staffing | 5.13 |
| 30 | D. Products and services | 5.01 |
| 31 | E. IT support systems | 5.25 |
| 32 | F. Leadership style | 5.08 |
| 33 | G. Internal structure | 5.62 |
| 34 | H. Policies | 4.95 |
| 35 | I. Business processes in general | 5.25 |
| 36 | i. Proposal preparation | 4.79 |
| 37 | ii. Pricing | 4.78 |
| 38 | iii. Billing, collections | 4.33 |
| 39 | iv. Servicing | 4.83 |
| 40 | J. Business strategy | 4.96 |
| 41 | K. Account strategy | 4.87 |
| 42 | L. Suppliers | 4.13 |
| 43 | M. Shared values, practices | 5.11 |
| 44 | N. Partners | 4.47 |
| 45 | The enterprise sells its products and | 5.08 |
| | services for use at many client locations. | |
| 46 | The enterprise's client satisfaction | 4.53 |
| | dashboard indicators are consistently green. | |
| 47 | Many organizations within this account use | 5.25 |
| | enterprise products and services. | |
| 47 | There is a significant “information | 5.10 |
| | component” to the services that the | |
| | enterprise provides to this client. | |
| 49 | The client deploys more advanced technology | 4.16 |
| | than the account has provided to them. | |
| 50 | It would be very difficult for a competitor | 4.30 |
| | to provide better products and services to | |
| | this client at comparable prices | |
| — | Enterprise margins could be considerably | — |
| | better if: | |
| 51 | A. Competitors couldn't readily | 4.46 |
| | duplicate enterprise offerings at lower | |
| | prices | |
| 52 | B. The enterprise had more flexibility | 5.10 |
| | in pricing approaches | |
| 53 | C. The enterprise was more efficient in | 5.46 |
| | service delivery | |
| 54 | D. The enterprise had a different | 5.00 |
| | relationship with the client | |
| — | This account has been innovative in its: | — |
| 55 | A. Product and service positioning | 4.03 |
| 56 | B. Product and service packaging | 3.90 |
| 57 | C. Pricing strategy | 3.33 |
| 58 | D. Communications and collaboration | 4.42 |
| | with the client | |
| 59 | E. Customer service approach | 4.20 |
| 60 | F. Use of technology | 3.96 |
| SECTION B-ENTERPRISE/ACCOUNT/CLIENT | | — |
| RELATIONSHIPS | | |
| 61 | The client buys commodity products and | 5.09 |
| | services from the enterprise. | |
| 62 | The predictable quality, cost and timing of | 4.28 |
| | specialized enterprise products and services | |
| | are primary drivers of our clients' success. | |
| 63 | The enterprise is partnered with the client | 4.00 |
| | with shared value propositions and metrics. | |
| 64 | The client buys from the enterprise based on | 3.67 |
| | price only. | |
| 65 | The client expects to derive unique value | 5.60 |
| | from its relationship with the enterprise. | |
| 66 | The enterprise demonstrates the ability to | 4.33 |
| | adapt to the client's changing business | |
| | environment. | |
| 67 | The client understands and counts on | 4.76 |
| | consistency of the enterprise's client- | |
| | facing processes (order processing, | |
| | delivery, installation, training, on-going | |
| | service, etc.) | |
| 68 | The client considers the account team to be | 3.71 |
| | adaptive and innovative. | |
| 69 | The client considers the enterprise to be | 3.22 |
| | adaptive and innovative. | |
| 70 | The account and client sometimes jointly | 5.04 |
| | develop products and services. | |
| 71 | The client knows the account team members by | 5.55 |
| | name. | |
| 72 | The account leader has access to and is | 6.02 |
| | known by the client's senior executives. | |
| 73 | The account leader is asked to provide input | 5.16 |
| | and feedback regarding the client's business | |
| | strategy, opportunities and issues. | |
| 74 | The account knows about and understands the | 5.16 |
| | client's most pressing business needs. | |
| SECTION C - THE CLIENT | | — |
| 75 | The client is entering some new market(s). | 5.84 |
| 76 | The client is expanding into new geographic | 5.78 |
| | markets. | |
| 77 | The client is introducing new products and | 5.94 |
| | services. | |
| 78 | The client is using web technologies | 5.90 |
| | (intranet, internet, extranet) to address | |
| | market shifts. | |
| 79 | The client has alliances or partnerships | 5.00 |
| | with competitors of the enterprise. | |
| — | The client's critical business performance | — |
| | issues lie in the area(s) of: | |
| 80 | A. Product/service refreshment | 5.51 |
| 81 | B. Product/service innovation | 5.77 |
| 82 | C. Market reach | 5.59 |
| 83 | D. Training and retaining staff | 4.45 |
| 84 | E. Reducing staff | 4.75 |
| 85 | F. Acquiring new skill sets, | 5.15 |
| | competencies | |
| 86 | G. Cost controls | 5.89 |
| 87 | H. Business positioning | 5.77 |
| 88 | I. Revenue generation in general | 6.00 |
| 89 | J. Competitive differentiation | 5.78 |
| 90 | K. Collections | 4.60 |
| 91 | L. Risk management | 4.84 |
| SECTION D - THE CLIENT'S INNOVATION | | — |
| ENVIRONMENT | | |
| 92 | Based on the last two years' activities, | 4.85 |
| | this client has the ability to deliver | |
| | innovative products and services. | |
| 93 | This client has allocated resources to | 4.91 |
| | develop fledgling ideas. | |
| 94 | This client supports risk taking. | 4.18 |
| 95 | This client accommodates and supports | 4.78 |
| | change. | |
| 96 | This client rapidly absorbs new technologies | 4.16 |
| | and business models. | |
| 97 | This client rapidly applies new technologies | 4.04 |
| | and business models. | |
| 98 | This client supports innovation in processes | 4.49 |
| | and relationships, as well as in products | |
| | and services. | |
| 99 | There is a strong level of trust and | 3.31 |
| | cooperation among the client's employees. | |
| 100 | There is a strong level of trust and | 3.41 |
| | cooperation between/among the client and its | |
| | partners/suppliers. | |
| 101 | Everyone on this client's teams is | 4.10 |
| | encouraged to provide innovative ideas. | |
| 102 | Client team members readily share | 3.90 |
| | information and knowledge with each other. | |
| 103 | The client uses web technologies to become | 5.44 |
| | more responsive to its stakeholders | |
| | (employees, partners, suppliers, etc.) | |
| 104 | The client uses web technologies (intranet, | 5.93 |
| | internet, extranet) for business purposes. | |
| 105 | The client uses web technologies as a key | 5.32 |
| | enabler of improving operations (supply | |
| | chain management, sales force management, | |
| | ERP, etc.) | |
| 106 | The client is very eager to use web | 5.92 |
| | technologies (even) more effectively to host | |
| | or stimulate future business. | |
| 107 | The client uses web technologies to create | 5.42 |
| | new value propositions and enhance top line | |
| | growth. | |
| 108 | The client uses web technologies to create | 5.18 |
| | new business models through innovative | |
| | relationships with its customers, partners, | |
| | suppliers, etc. | |
| SECTION E - THE ACCOUNT'S INNOVATION | | — |
| ENVIRONMENT | | |
| 109 | Based on the last two years' activities, | 4.61 |
| | this account has the ability to deliver | |
| | innovative products and services. | |
| 110 | This account has allocated resources to | 3.82 |
| | develop fledgling ideas. | |
| 111 | This account supports risk taking. | 3.44 |
| 112 | This account accommodates and supports | 4.57 |
| | change. | |
| 113 | This account rapidly absorbs new | 3.96 |
| | technologies and business models. | |
| 114 | This account rapidly applies new | 3.97 |
| | technologies and business models. | |
| 115 | This account supports innovation in | 4.25 |
| | processes and relationships, as well as in | |
| | products and services. | |
| 116 | There is a strong level of trust and | 4.40 |
| | cooperation among account team members. | |
| 117 | There is a strong level of trust and | 3.76 |
| | cooperation between/among the account and | |
| | its partners/suppliers. | |
| 118 | Everyone on this account team is encouraged | 4.37 |
| | to provide innovative ideas. | |
| 119 | Account team members readily share | 4.55 |
| | information and knowledge with each other. | |
| 120 | The account uses web technologies to become | 4.69 |
| | more responsive to its stakeholders (team | |
| | members, partners, suppliers, etc.) | |
| 121 | The account uses web technologies for | 5.10 |
| | business purposes. | |
| 122 | The account uses web technologies as a key | 4.70 |
| | enabler of improving operations (supply | |
| | chain management, sales force management, | |
| | ERP, etc.) | |
| 123 | The account is very eager to use web | 4.82 |
| | technologies (even) more effectively to host | |
| | or stimulate future business. | |
| 124 | The account uses web technologies to create | 4.41 |
| | new value propositions and enhance top line | |
| | growth. | |
| 125 | The account uses web technologies to create | 4.23 |
| | new business models through innovative | |
| | relationships with its clients, partners, | |
| | suppliers, etc. | |

For the purpose of convenience in explaining the present invention, the left column of TABLE 1 includes a unique question number for each question. However, the survey can be administered without the use of any question numbers. Further, the questions in TABLE 1 could be presented to a person in an order which is significantly different from the order shown in TABLE 1.

The questions in TABLE 1 are grouped into five categories, which are (A) Account Growth History, (B) Enterprise/Account/Client Relationships, (C) The Client, (D) The Client's Innovation Environment, and (E) The Account's Innovation Environment. The questions are shown with this grouping in TABLE 1 in order to facilitate an understanding of the present invention. However, as noted above, the questions could be presented in a different order, for example a random order in which questions from various categories were interleaved.

In order to answer each question in TABLE 1, a person provides an integer number selected from a scale from 0 through 7. As shown in TABLE 2, the eight integer values 0 through 7 respectively represent “No Opinion”, “Strongly Disagree”, “Disagree”, “Somewhat Disagree”, “Neutral”, “Somewhat Agree”, “Agree”, and “Strongly Agree”.

TABLE 2
QUESTION ANSWER SCALE

| | |
|---|---|
| No Opinion | 0 |
| Strongly Disagree | 1 |
| Disagree | 2 |
| Somewhat Disagree | 3 |
| Neutral | 4 |
| Somewhat Agree | 5 |
| Agree | 6 |
| Strongly Agree | 7 |

FIG. 3 is a flowchart showing a sequence of blocks 71-73 that represent successive steps in a procedure for assessing and identifying innovation opportunities which are likely to stimulate business growth in the context of an enterprise and client, such as the enterprise and client shown at 51 and 52 in FIG. 2. The procedure begins in block 71, where the questions in the survey 41 (TABLE 1) are evaluated and answered. The questions may all be answered by only a single person, who is either in a position to know the answers to all the questions, or who is in a position to gather information from others and then answer the questions. More typically, however, a number of different persons in the enterprise 51, and possibly one or more persons in the client 52, would each separately answer all of the questions in the survey 41, without consulting with other person.

In the disclosed embodiment, the questions in the survey 41 are presented electronically, and the answers are recorded electronically. In particular, the survey 41 is configured as a hypertext document of the type commonly referred to as an Internet Web page, which can be accessed with a password using any known network browser program through the network 14, for example from any one of the workstations 16-18. The answers are then recorded in a computer file or database that can be accessed by the survey processing program 42. Alternatively, the survey processing program 42 could have an operational mode in which it presented the questions from the survey 41 and then recorded the answers. As yet another alternative, the survey 41 could be configured as a paper form on which the answers are recorded manually, and then the answers could be manually entered into the survey processing program 42.

In FIG. 3, after answers to the questions in the survey 41 have been recorded from all of the persons who are taking the survey 41, activity proceeds from block 71 to block 72. In block 72, the survey processing program 42 analyzes the answers that have been recorded. The first step in this process is to calculate for each question an average of all answers received from various persons. For example, with respect to question 1, assume that twenty persons completed the survey, and that each such person provided a respective answer for question 1 in the form of an integer from 0 to 7. The survey processing program 42 adds up these twenty integer answers received for question 1, and then divides by 20 in order to compute an average score for question 1. This computation of an average score is carried out separately for each of the 125 questions in the survey. The right column in TABLE 1 shows hypothetical sample scores for each of the 125 questions, where each such score is an average of several answers received for that question.

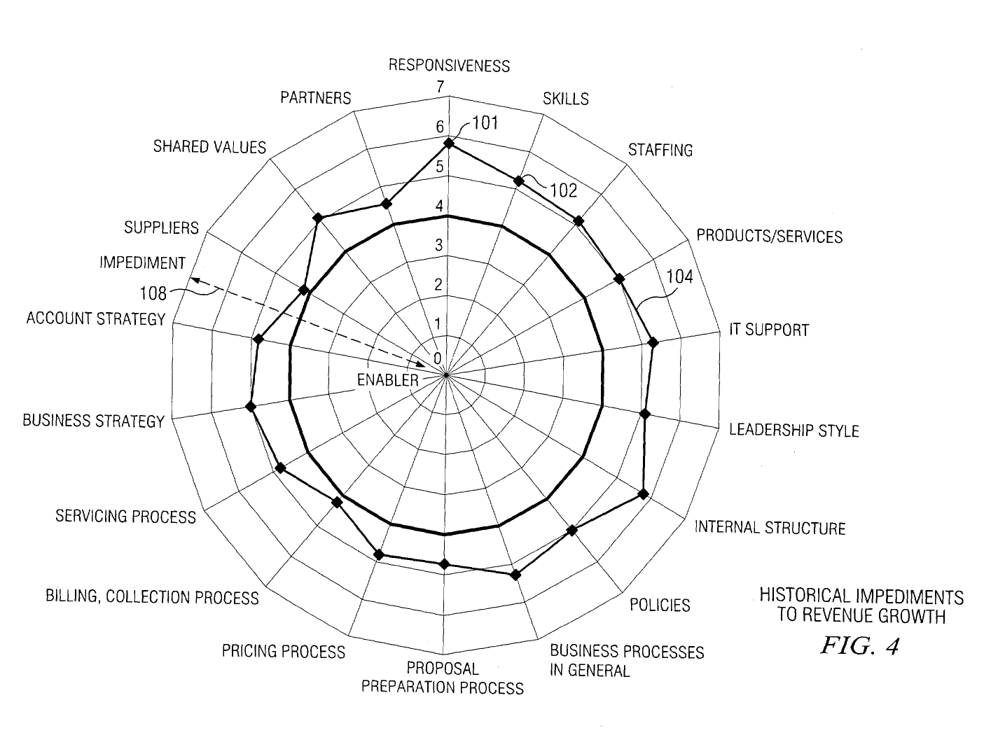

After calculating an average score in this manner for each question, the survey processing program 42 carries out some further calculations, which for convenience will be described in detail later. Then, activity proceeds from block 72 to block 73 in FIG. 3, where the survey processing program 42 uses the printer 21 to print a report. In the disclosed embodiment, the report includes a number of diagrams, examples of which are shown in FIGS. 4 though 14. FIGS. 4 through 14 each represent a respective diagram which is based on the sample scores shown in the right column of TABLE 1. The diagrams shown in FIGS. 4-14 are exemplary. The report could include a larger or smaller number of diagrams, and some or all of the diagrams shown in FIGS. 4-14 could be replaced with other diagrams.

The diagrams shown in FIGS. 4-10 are each a type of diagram commonly referred to as a “spider” diagram. This is because, as evident from FIG. 4, these diagrams each have the general appearance of the web of a spider. Looking specifically at FIG. 4, the diagram has eighteen spokes or lines extending radially outwardly in different directions from a center point. Adjacent the outer end of each spoke is a respective label. The center point is surrounded by seven regular polygons, which have different sizes and are concentric.

In FIG. 4, the center point is identified with integer 0, and the polygons are identified with successive integer numbers of 1 through 7. The center point and seven polygons respectively correspond to the integers 0 to 7 in the scoring scale shown in TABLE 2. The polygon identified by integer 4 is identified with a bold line, because it represents the “Neutral” score in TABLE 2.

Beginning from the “twelve o'clock” position at the top of the diagram in FIG. 4, and proceeding in a clockwise direction around the diagram, each spoke of the diagram corresponds to a respective one of eighteen questions in TABLE 1, which are questions 27-44. More specifically, it will be noted from the right column of TABLE 1 that the sample average score calculated for question 27 is 5.81, and this value is indicated along the corresponding spoke in FIG. 4 by a point 101. Similarly, the sample average score for question 28 is 5.25, and this value is indicated along the corresponding spoke by as point 202. The sample average scores for questions 29-44 are represented in a similar manner by other points in FIG. 4. The eighteen points for questions 27-44 are connected by a line 104, which effectively forms an irregular polygon. Thus, this irregular polygon 104 is a graphical representation of the average answers to eighteen related questions in the survey. It can be quickly visually compared to the regular polygon which is identified by the integer 4 and which represents the “Neutral” score, in order to quickly ascertain the extent to which the actual scores fall inside or outside the “Neutral” polygon.

The diagram of FIG. 4 has a broken line 108 with arrowheads at each end, with the inner arrowhead located near the center point which is identified by the integer 0, and the outer arrowhead located near the regular polygon which is identified by the integer 7. The inner end of the line 108 is labeled “Enable”, and the outer end is labeled “Impediment”. This is an indication that, if a point representing a score (such as the point 101) is near the outer portion of the diagram, it represents a condition which can serve as an impediment to growth, whereas if a point is near the center of the diagram, it represents a condition which can encourage growth.

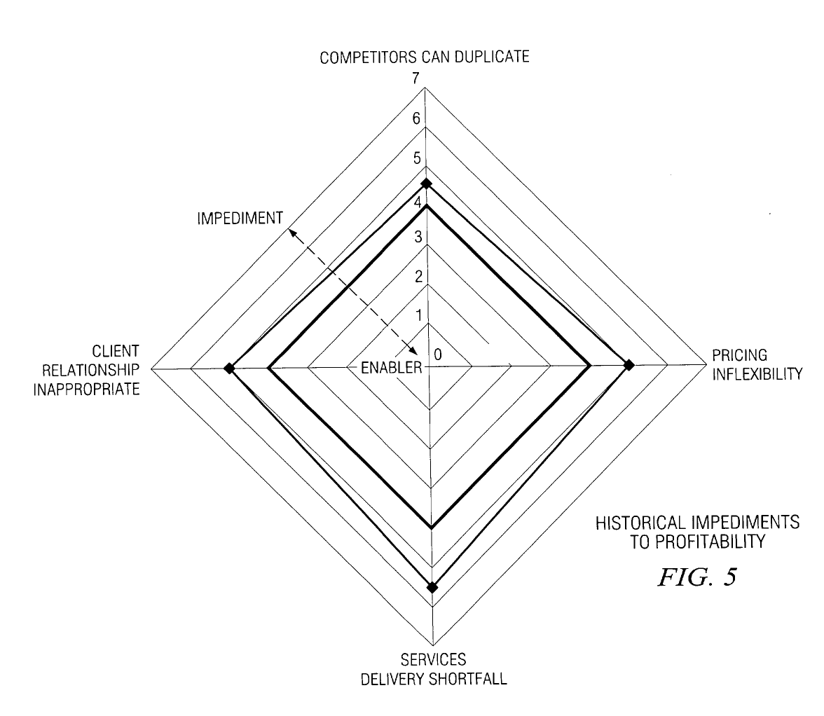

FIG. 5 is a diagram similar to FIG. 4, but showing historical impediments to profitability. In FIG. 5, beginning with the spoke at twelve o'clock and working clockwise, the spokes respectively correspond to survey questions 51-54 (TABLE 1).

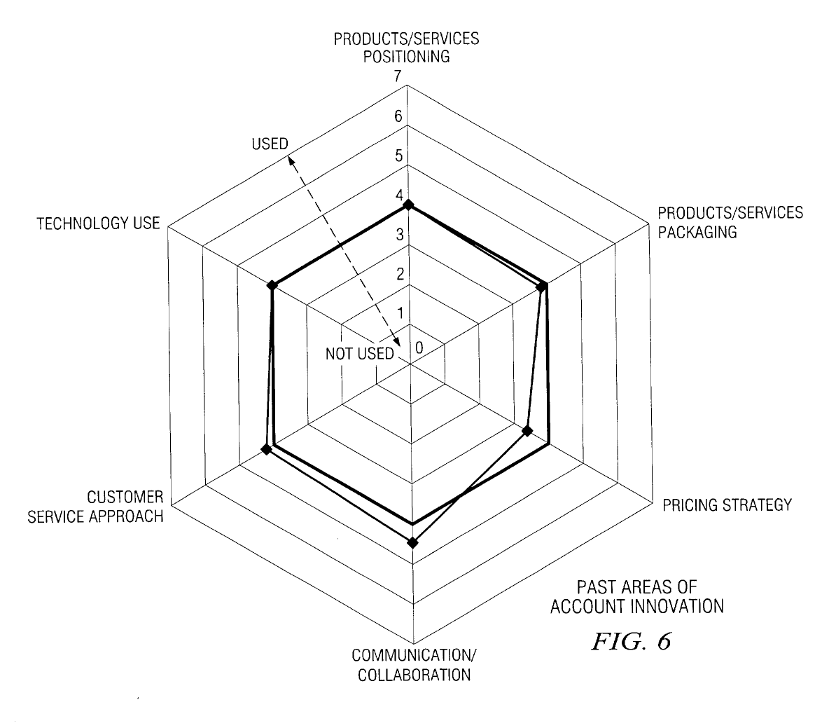

FIG. 6 is a diagram similar to FIG. 4, but showing past areas of account innovation. In other words, FIG. 6 provides a graphical representation of areas of past innovation by the portion 54 of the enterprise 51 which is responsible for the client 52. Working clockwise from the spoke at twelve o'clock, the spokes respectively correspond to survey questions 55-60 (TABLE 1).

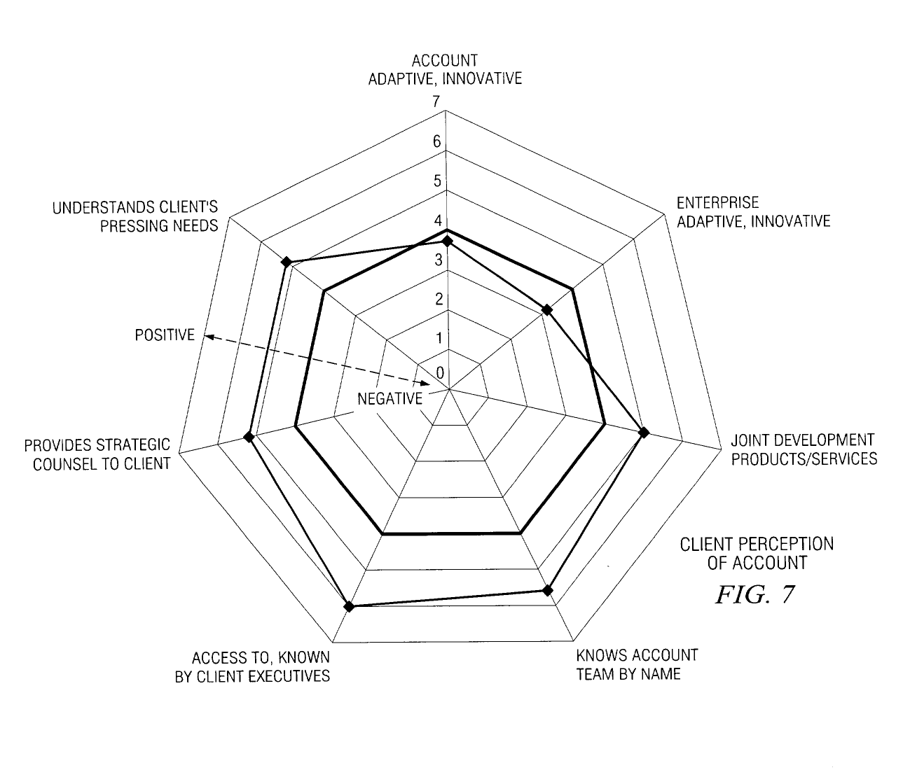

FIG. 7 is a diagram similar to FIG. 4, but showing the perception which the client 52 has of the account 54. That is, FIG. 7 provides a graphical representation, as to a plurality of predetermined factors, of the perception by the client 52 of the portion 54 of the enterprise 51 which is responsible for the client. Working clockwise from the twelve o'clock position, the spokes respectively correspond to survey questions 68-74 (TABLE 1).

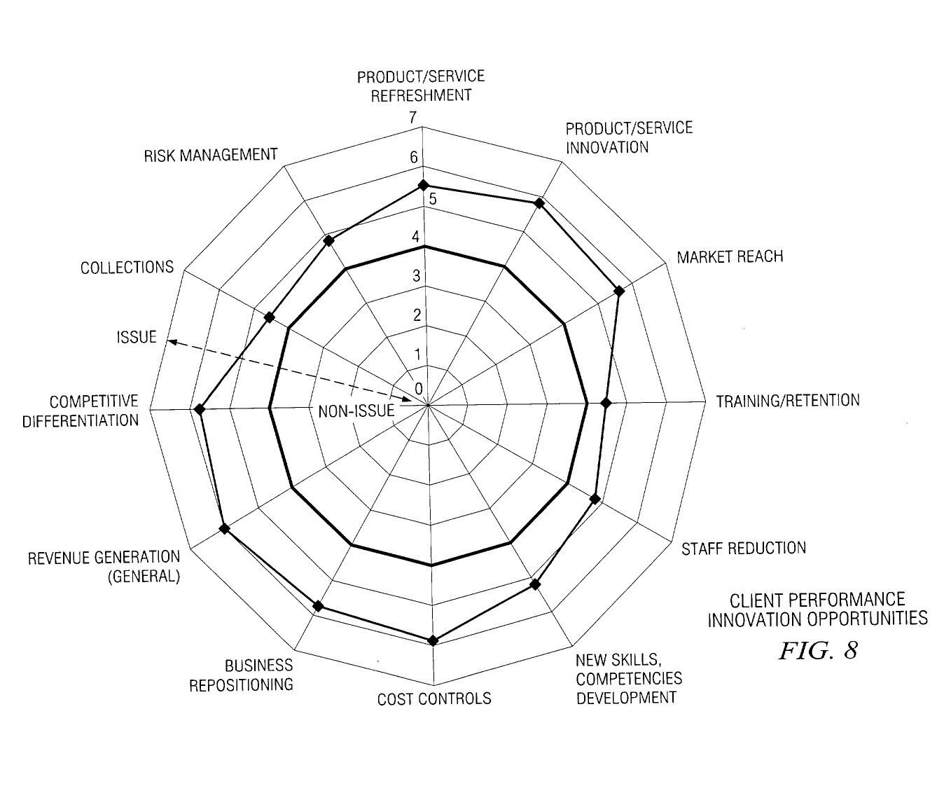

FIG. 8 is a diagram similar to FIG. 4, but showing client performance innovation opportunities. That is, FIG. 8 provides a graphical representation of business and offering innovation factors relating to the client 52. Working clockwise from the twelve o'clock position, the spokes respectively correspond to survey questions 80-91 (TABLE 1).

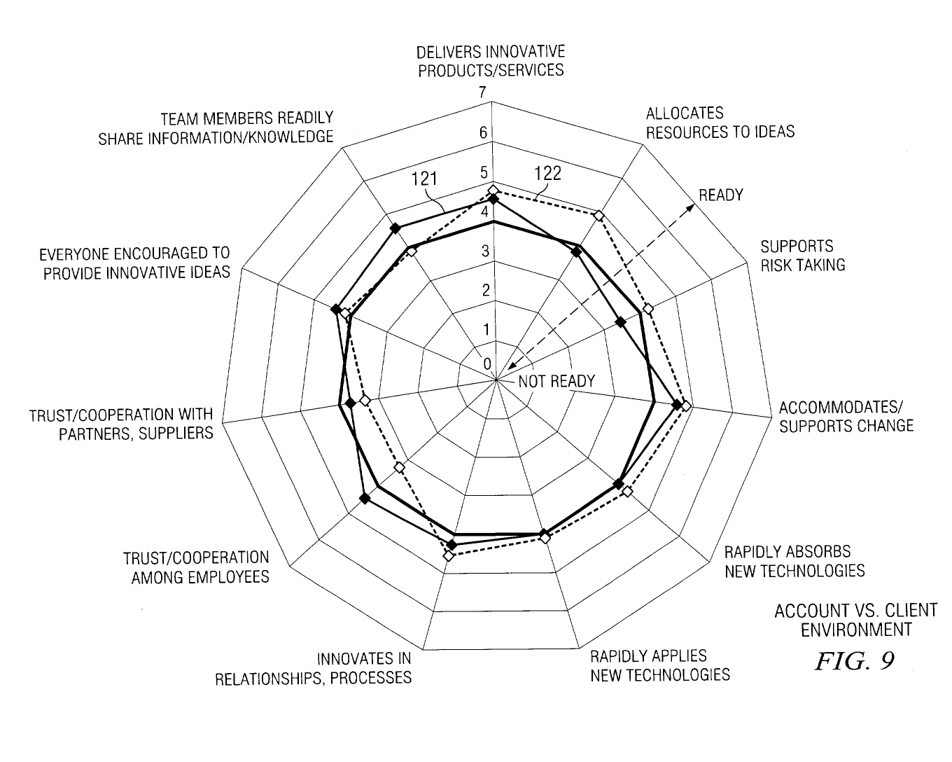

FIG. 9 is a diagram of the type shown in FIG. 4, but with a difference. In particular, FIG. 9 has two lines 121 and 122, which each correspond to a different group of questions. In particular, working clockwise from the twelve o'clock position, the line 121 corresponds to survey questions 109-119 (TABLE 1), and represents the capacity for innovation by the account 54 with respect to several predetermined factors. The line 122 corresponds to survey questions 92-102, and represents the capacity for innovation by the client 52 with respect to each of the same predetermined factors. Thus, FIG. 9 provides a graphical comparison of the capacity for innovation by each of the client 52 and the account 54 with respect to the same predetermined factors.

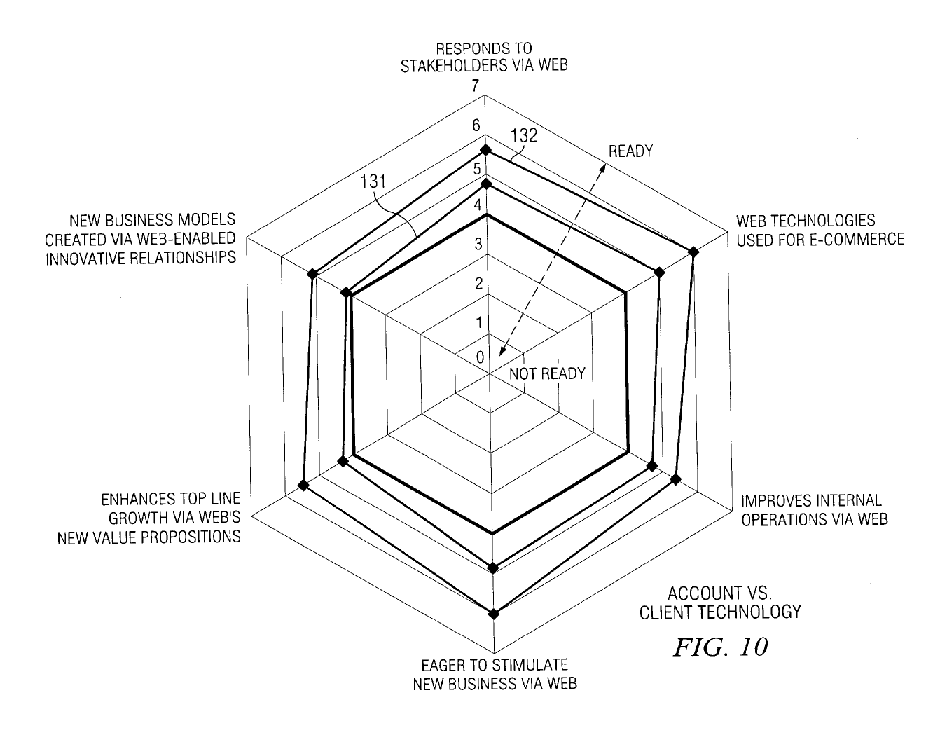

FIG. 10 is a diagram similar to FIG. 9. FIG. 10 includes a line 131 which, working clockwise from the twelve o'clock position, corresponds to survey questions 120-125 (TABLE 1), and serves as a graphical representation of the extent to which various predetermined factors involving digital technology are used by the account 54. Working clockwise from the twelve o'clock position, line 132 corresponds to survey questions 103-108 (TABLE 1), and represents the extent to which various predetermined factors involving digital technology are used by the client 52. Thus, FIG. 10 provides a graphical comparison, for a plurality of predetermined factors, of the extent to which digital technologies are used by each of the client 52 and the account 54.

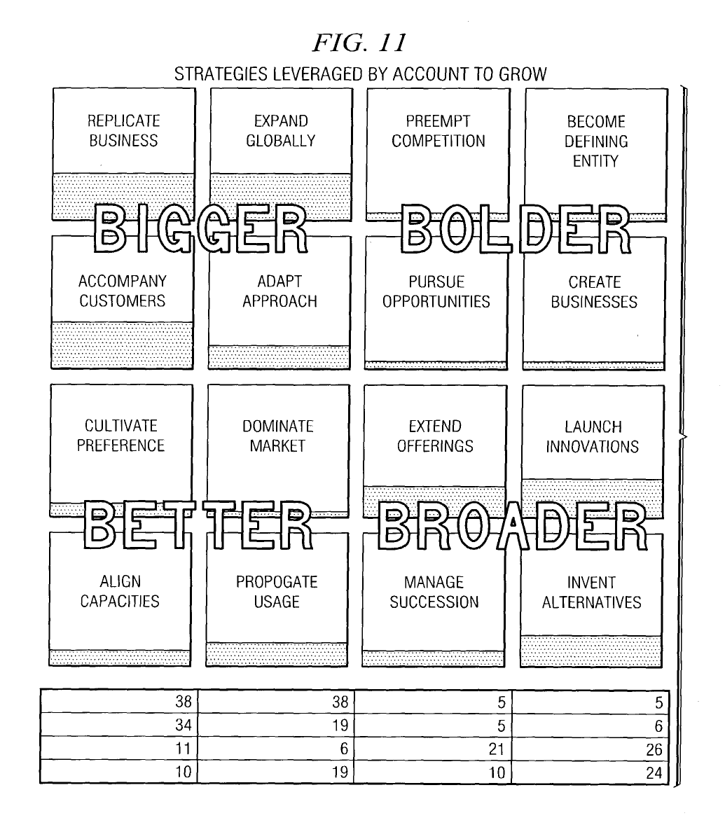

FIG. 11 is a diagram showing sixteen strategies, and indicating the extent to which each strategy appears to be currently utilized by the account 54 to encourage growth in the relationship between the enterprise 51 and the client 52. These sixteen strategies are presented in the upper portion of FIG. 11 as a 4×4 array of rectangular blocks, where each block corresponds to a respective strategy and has a corresponding label. The sixteen blocks are arranged in four quadrants which each include four related blocks, and which each have a label. In particular, the upper left quadrant of four blocks is labeled “Bigger”, the upper right quadrant of four blocks is labeled “Bolder”, the lower left quadrant of four blocks is labeled “Better”, and the lower right quadrant of four blocks is labeled “Broader”.

Each of the sixteen blocks is split into 2 portions by a horizontal line, where the portion below the line is shaded. The shaded portion of each block represents a percentage attributable to the associated strategy, where a larger percentage represent a greater utilization of the strategy than a smaller percentage. In the lower portion of FIG. 11 is a table with sixteen cells arranged in a 4×4 array of rows and columns. Each cell in this table contains a number which represents a percentage. Thus, for example, the upper left cell in this table contains the value 38, which represents 38%. Each cell in the table corresponds to a respective one of the blocks in the array above it. In particular, each cell corresponds to the block which has the same relative position within the 4×4 array that the cell has in the 4×4 table. For example, the upper left cell in the table contains a value representing 38%, and the corresponding block labeled “Replicates Business” in the upper left corner of the array has a shaded portion which is 38% of the block. Similarly, the lower left cell in the table contains a value representing 10%, and corresponding block labeled “Align Capacities” in the lower left corner of the array has a shaded portion which is 10% of the block.

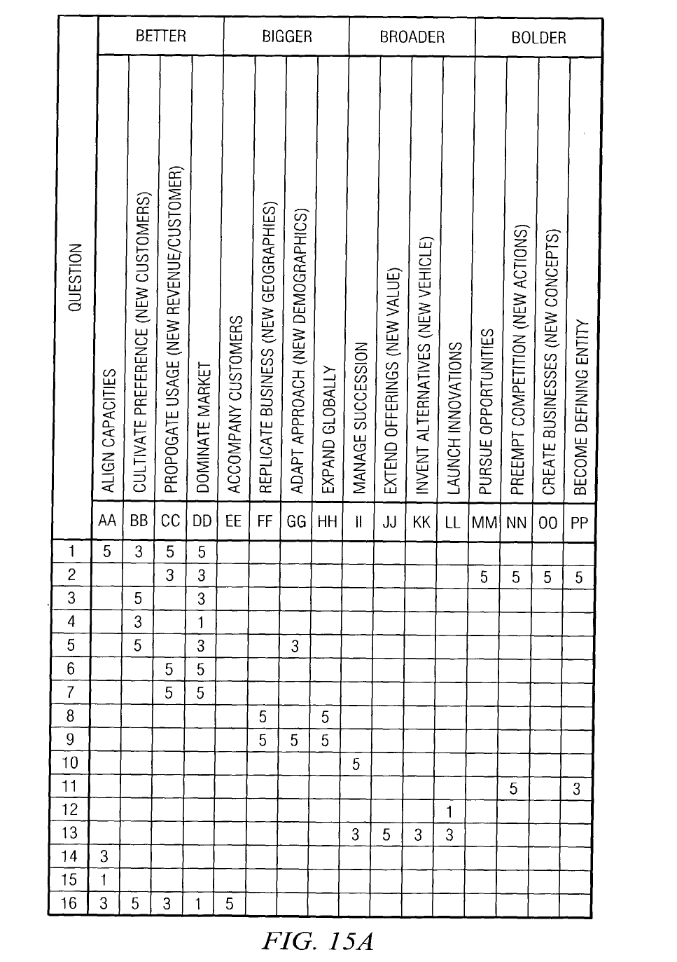

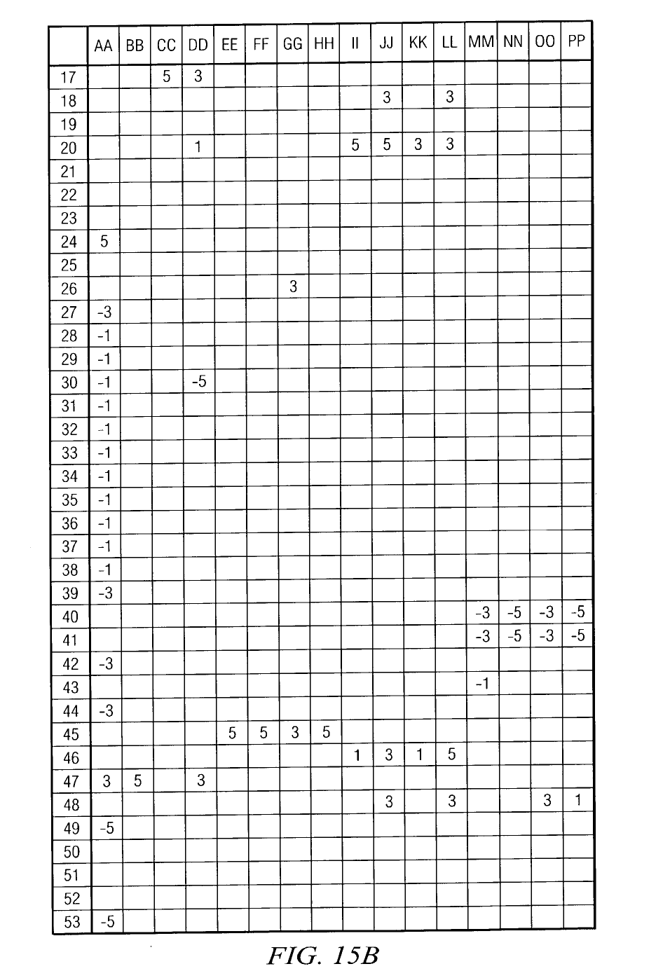

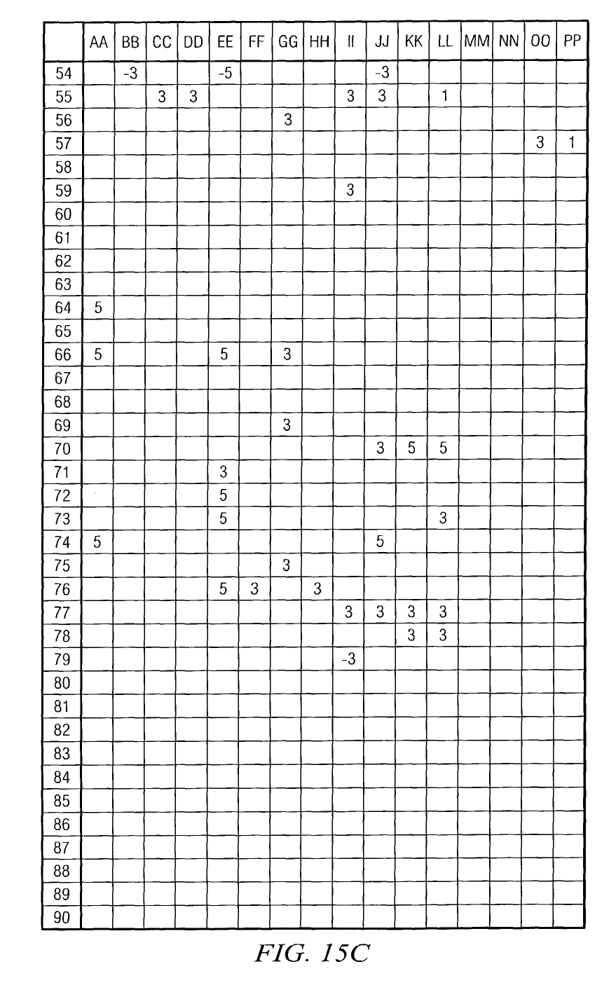

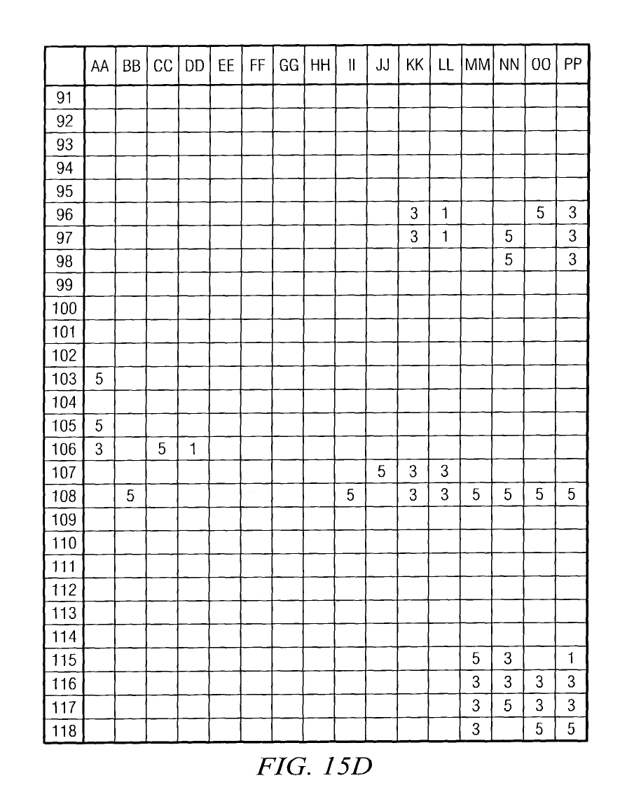

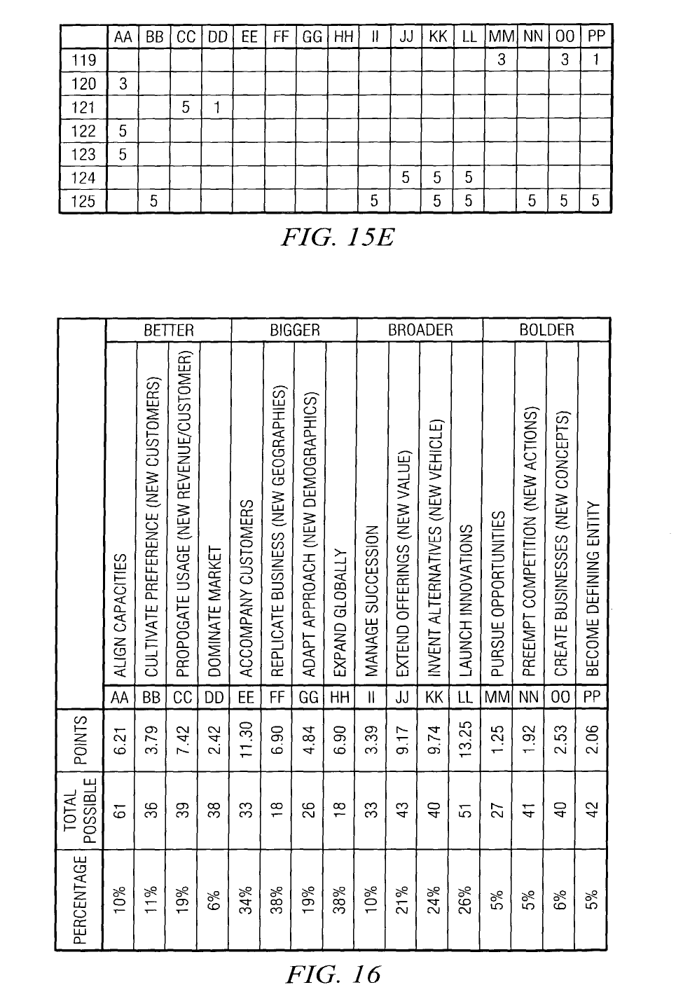

The manner in which the sixteen different percentage values depicted in FIG. 11 are calculated will now be described in more detail. FIG. 15 is a table with seventeen columns, where the left column contains the numbers of the 125 questions that appear in TABLE 1. The remaining sixteen columns each have a label at the top, such as “Align Capacities”, and it will be noted that each such label corresponds to the label in a respective one of the sixteen blocks shown in the upper portion of FIG. 11. For convenience, each of these sixteen columns in the table in FIG. 15 is also identified with a two-letter identifier, such as “AA”.

Focusing on the column AA, it will be noted that some but not all cells in the column contain a positive or negative integer number, and each such number represents a weight assigned to the associated survey question. In the disclosed embodiment, the possible weights are 1, 3 and 5, which indicate varying degrees of positive impact for the associated question, or −1, −3 and −5, which indicate varying degrees of negative impact for the associated question.

As discussed above, the questions of the survey 41 shown in TABLE 1 are administered to a number of persons, and the multiple responses to each question are averaged in order to obtain a score for each question, such as the sample scores shown in the right column of TABLE 1. These scores are then used to calculate a point value for each cell in the table of FIG. 15 that contains a numerical weight. In particular, for each such cell, the point value for the cell is calculated using the following equation:

$$Points = \frac{Score - 4}{3} \times Weight$$

where “weight” is the numerical value appearing within that cell in the table of FIG. 15, and where “score” is the average score calculated for the associated question. As one example, for the cell in FIG. 15 which is in column AA and corresponds to question 1, the point value would be calculated in the following manner using the sample score set forth for question 1 in the right column of TABLE 1:

$$Points = \frac{( 3.93 - 4 )}{3} \times 5 = \frac{( - .0 .07 ) \times 5}{3} = - 0.12$$

Some of the point values calculated in this manner will be positive, and some will be negative. After a respective point value has been calculated for each cell in column AA that contains a numerical weight, the resulting point values in column AA are added up in order to obtain a point value for the entire column AA. FIG. 16 is a table with sixteen columns that each correspond to one of the 16 columns on the right side of the table of FIG. 15. The first row in the table of FIG. 16 shows the point values which are obtained for each of the sixteen columns in TABLE 15 using the sample scores set forth in the right column of TABLE 1.

The second row in FIG. 16 gives the total possible point value for each column. This value is calculated for each column by ignoring the weights in the column which are negative numbers, and by assuming that each question associated with a positive weight has received the maximum possible score of 7.0. The third row in FIG. 16 expresses the value in the first row of each column as a percentage of the value in the second row. It should be noted that the sixteen percentage values in the third row of FIG. 16 are the same percentage values that appear in the table in the lower portion of FIG. 11, each of which corresponds to the shaded portion in a respective block in the upper portion of FIG. 11.

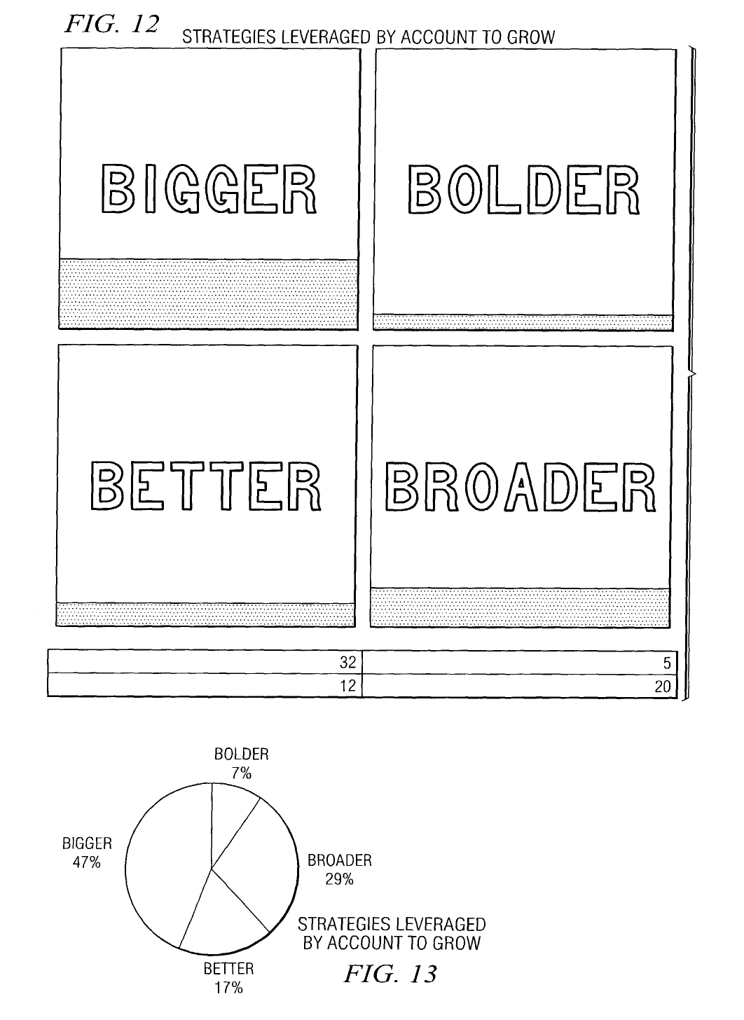

FIG. 12 is a diagram which is a simplified version of the diagram of FIG. 11, where the four blocks in each quadrant of FIG. 11 are combined into a single block for purposes of FIG. 12. This is effected by taking the four percentage values associated with the four blocks in a quadrant of FIG. 11, adding up these four percentage values, and then dividing by four in order to obtain an average. Thus, for example, with respect to the upper left quadrant, the percentage values for the four blocks would be combined as follows:

$$\frac{( 38 \% + 38 \% + 34 \% + 19 \% )}{4} = 32.25 \%$$

Rounding this combined percentage value of 32.25% to the nearest integer value of 32%, it will be noted that this is the percentage shown by the shaded area in the upper left block of the 2×2 array in the upper portion of FIG. 12, and is the value set forth in the upper left cell in the 2×2 table at the bottom of FIG. 12. A similar calculation is carried out to obtain percentage values for each of the other three blocks in the upper portion of FIG. 12.

FIG. 13 is a diagram of the type commonly known as a pie chart. The pie chart of FIG. 13 has four sections, each of which corresponds directly to one of the four categories shown in FIG. 12 (Bigger, Bolder, Better and Broader). The percentage values shown in FIG. 13 are normalized versions of the percentage values used in FIG. 12. For example, the percentage value of 20% in FIG. 12 for the “Broader” category is divided by the sum of all four percentage values in FIG. 12 to obtain a normalized percentage of 29% for the “Broader” section of the pie chart, as follows:

$$\frac{20 \%}{32 \% + 12 \% + 5 \% + 20 \%} = \frac{20}{69} \% = 28.99 \% ≅ 29 \%$$

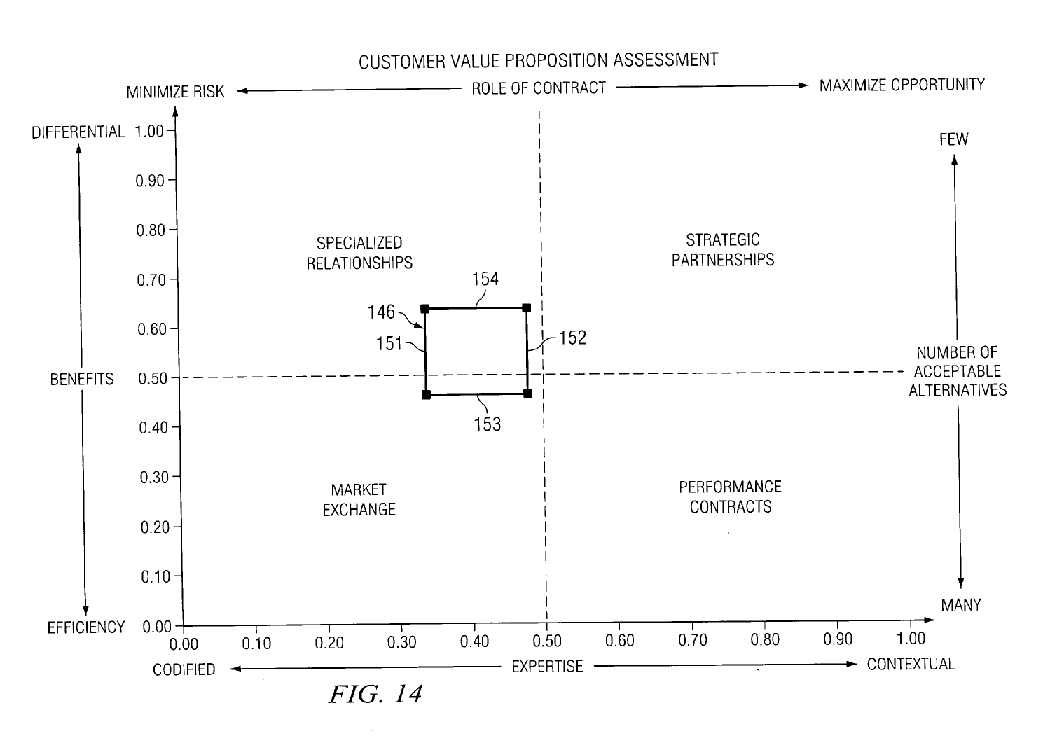

FIG. 14 is a diagram which is a graphical representation of a value proposition of the enterprise 51, as viewed by the client 52. FIG. 14 includes a rectangle 146 defined by four lines 151-154, and this rectangle 146 is the portion of FIG. 14 which varies in dependence on the scores from a particular administration of the survey 41. The locations of the lines 151-154 are determined in the following manner.

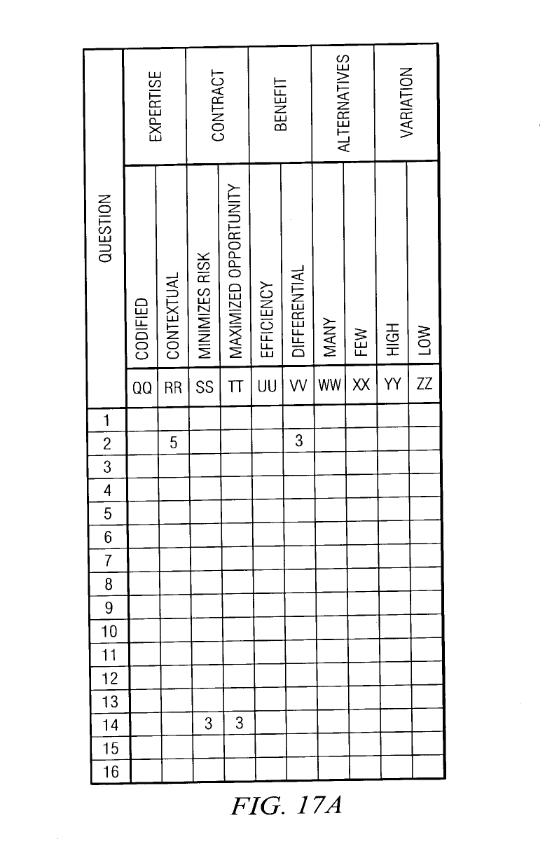

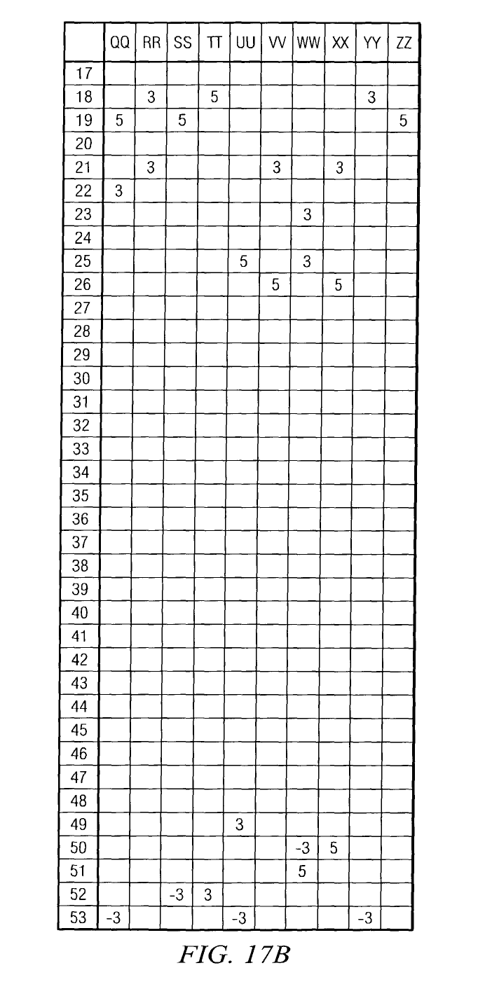

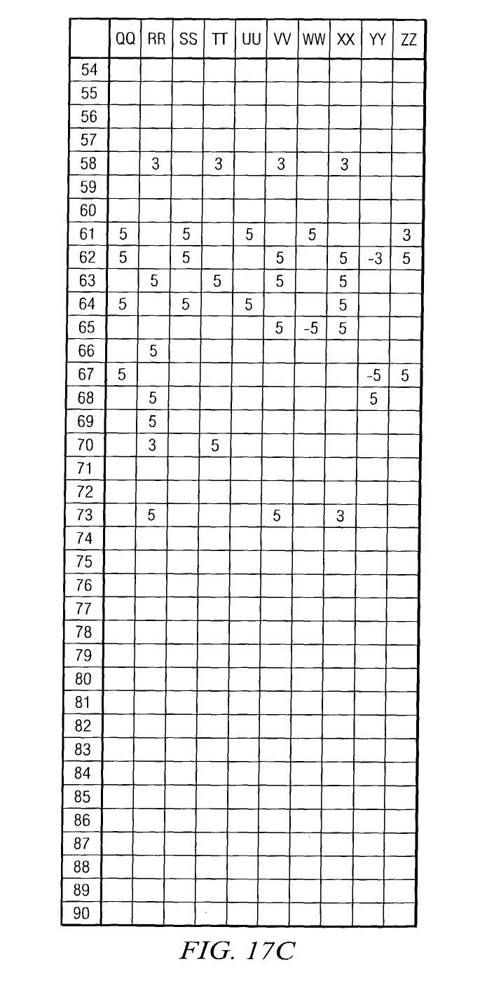

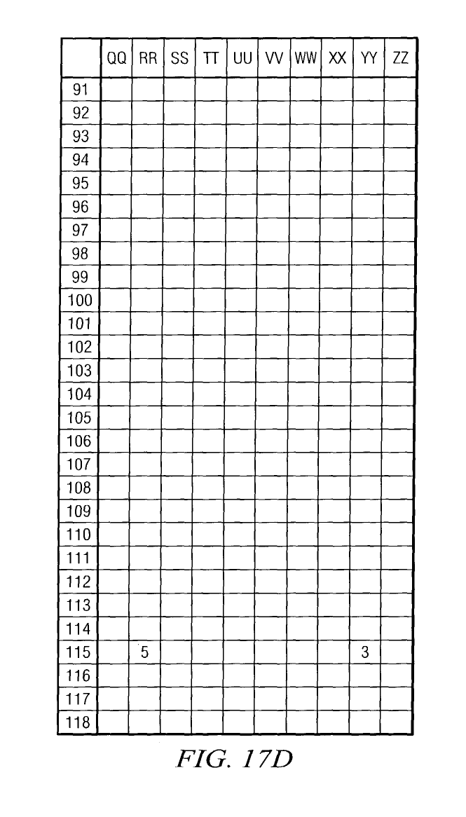

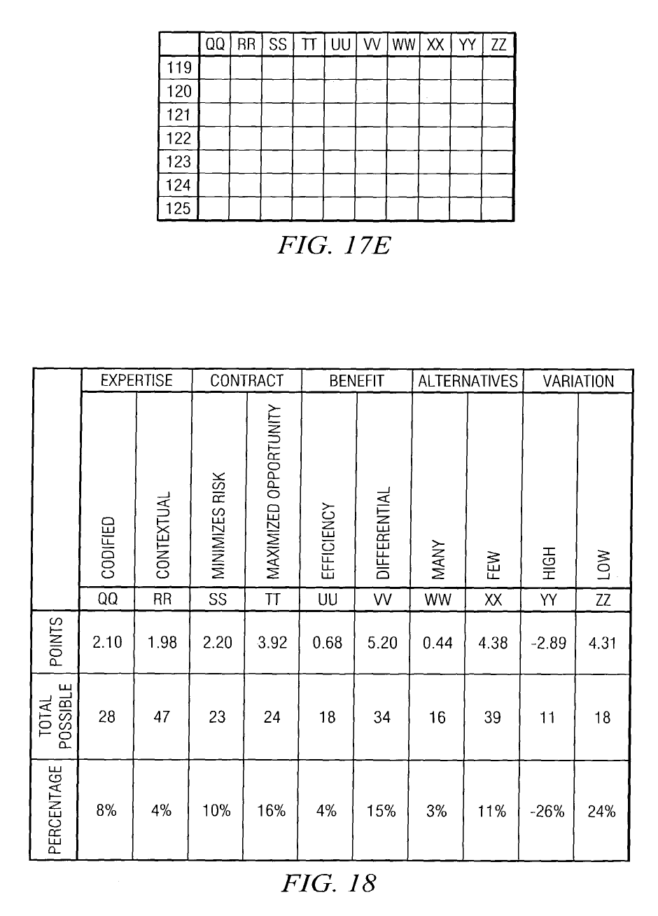

FIG. 17 is a table which is somewhat similar to the table of FIG. 15, except that the sixteen columns AA through PP in the table of FIG. 15 are replaced with ten columns QQ through ZZ in the table of FIG. 17. Selected cells throughout the table of FIG. 17 contain numerical weights, in a manner similar to the weights in the table of FIG. 15. Further, in the same manner described above in association with FIG. 15, point values, total possible points and percentage values are calculated for each column in the table of FIG. 17, and FIG. 18 is a table which shows these results when the calculations are carried out using the sample scores shown in the right column of TABLE 1.

Next, the positions of the lines 151 and 152 along the horizontal axis in FIG. 14 are calculated using values from the last row of the table in FIG. 18, in the following manner:

$$\begin{matrix}Line 151 = 0.5 - \frac{( QQ + SS + ZZ )}{3} \\ = 0.5 - \frac{( 0.08 + 0.10 + 0.24 )}{3} \\ = 0.5 - \frac{0.42}{3} = 0.36 \\ Line 152 = 0.5 + \frac{( RR + TT + YY )}{3} = 0.48\end{matrix}$$

Similarly, the positions of the lines 153 and 154 along the vertical axis in FIG. 14 are calculated using values from the last row in FIG. 18, in the following manner:

$$Line 153 = 0.5 - \frac{( UU + WW )}{2} = 0.47$$

$$Line 154 = 0.5 + \frac{( VV + XX )}{2} = 0.63$$

In FIG. 14, the extent to which the rectangle 146 has a portion within any one of the four quadrants indicates the extent to which the value provided by the enterprise 51 to the client 52 is perceived to involve activity described by the label within that quadrant, such as “Specialized Relationships”, “Strategic Partnerships”, “Market Exchange”, and/or “Performance Contracts”.

As explained above, the server 12 uses the printer 21 to print a report, and in the disclosed embodiment the report includes the diagrams of FIGS. 4-14. In a variation, it would be possible for the survey processing program 42 to cause the server 12 to permit a person to see a preview of the report before the report is printed, and to add some text to the report in the form of comments and/or opinions regarding the meaning of the various diagrams that will be included in the report. Then, when the report is printed, it will include not only the diagrams of FIGS. 4-14, but also the text which presents associated comments and/or opinions.

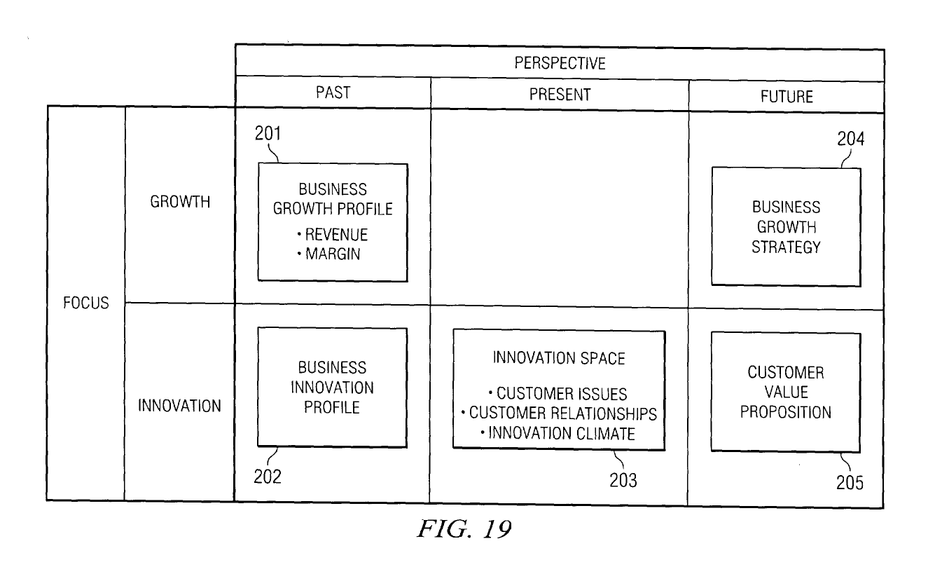

FIG. 19 is a diagram which breaks down growth and innovation into three time categories (past, present and future). The diagrams of FIGS. 4-5 basically correspond to block 201 in FIG. 19 (past growth), the diagram of FIG. 6 basically corresponds to block 202 (past innovation), the diagrams of FIGS. 7-10 basically correspond to block 203 (present innovation), the diagrams of FIGS. 11-13 basically correspond to block 204 (future growth), and the diagram of FIG. 14 basically corresponds to block 205 (future innovation).

The present invention provides a number of advantages. One such advantage is the provision of a tool which is efficient and effective for assessing opportunities to stimulate business growth through activities focused on innovation. This provides the capability for business growth which is innovation driven and thus drives the market, in contrast to pre-existing techniques which tend to be market driven. One advantageous application for this tool is a context in which an enterprise is providing a client with offerings such as products or services. In a given situation involving a particular enterprise and client, the tool can be used periodically in order to refine over time the plans which are developed to stimulate growth through innovation. The tool is advantageous for increasing opportunities for success in what is commonly known as the digital economy. A further advantage is realized where the tool includes a survey which is administered and then evaluated with a high degree of automation. Another advantage exists where the tool is used to print a report, which is then used to formulate one or more initiatives that are intended to stimulate growth through innovation. At least some of the initiatives are then put into practice.

Although one embodiment has been illustrated and described in detail, it will be understood that various substitutions and alterations are possible without departing from the spirit and scope of the present invention, as defined by the following claims.

What is claimed is:

1. A method, comprising:
obtaining answers to a plurality of predetermined questions from at least one person, said questions relating to a situation involving a specified client and a specified enterprise, said enterprise providing said client with offerings that include at least one of a product and a service; and
utilizing said answers to at least some of said questions to prepare a report, including identifying within said report areas of past innovation within said enterprise with respect to the offerings provided to said client, and areas currently appropriate for innovation within said enterprise with respect to the offerings provided to said client.

2. A method according to claim 1, wherein said identifying of said areas includes providing within said report a graphical representation of said areas of past innovation within said enterprise and a graphical representation of said areas currently appropriate for innovation within said enterprise.

3. A method according to claim 1, wherein said identifying of areas includes identifying within said report areas currently appropriate for innovation by said client.

4. A method according to claim 3, wherein said identifying of said areas includes providing within said report a graphical representation of business and offering innovation factors relating to said client.

5. A method according to claim 3, wherein said identifying of said areas includes providing within said report a graphical representation as to a plurality of predetermined factors of the perception by said client of a portion of said enterprise responsible for said client.

6. A method according to claim 3, wherein said identifying of said areas includes providing within said report a graphical comparison for a plurality of predetermined factors of capacity for innovation by each of said client and a portion of said enterprise responsible for said client.

7. A method according to claim 3, wherein said identifying of said areas includes providing within said report a graphical comparison for a plurality of predetermined factors of the extent to which digital technologies are used by each of said client and a portion of said enterprise responsible for said client.

8. A method according to claim 1, wherein said utilizing of said answers includes identifying within said report a value proposition of said enterprise as viewed by said client.

9. A method according to claim 8, wherein said identifying of said value proposition includes providing within said report a graphical representation of said value proposition.

10. A method according to claim 8, wherein said utilizing of said answers includes identifying within said report areas currently appropriate for encouraging growth in the relationship between said enterprise and said client.

11. A method according to claim 10, wherein said identifying of said areas includes providing within said report a graphical representation of said areas currently appropriate for encouraging growth.

12. A method according to claim 10, wherein said utilizing of said answers includes identifying within said report areas of past growth in the relationship between said enterprise and said client.

13. A method according to claim 12, wherein said identifying of said areas of past growth includes providing within said report a graphical representation of historical impediments to growth.

14. A method according to claim 12, wherein said identifying of said areas of past growth includes providing within said report a graphical representation of historical impediments to profitability.

15. A computer-readable medium encoded with a computer program which is operable when executed to:
obtain answers to a plurality of predetermined questions from at least one person, said questions relating to a situation involving a specified client and a specified enterprise, said enterprise providing said client with offerings that include at least one of a product and a service; and
utilize said answers to at least some of said questions to prepare a report, including identifying within said report areas of past innovation within said enterprise with respect to the offerings provided to said client, and areas currently appropriate for innovation within said enterprise with respect to the offerings provided to said client.

16. A computer-readable medium according to claim 15, wherein said program is further operable when executed to effect said identifying of said areas in a manner which includes providing within said report a graphical representation of said areas of past innovation within said enterprise and a graphical representation of said areas currently appropriate for innovation within said enterprise.

17. A computer-readable medium according to claim 15, wherein said program is further operable when executed to effect said identifying of areas in a manner which includes identifying within said report areas currently appropriate for innovation by said client.

18. A computer-readable medium according to claim 17, wherein said program is further operable when executed to effect said identifying of said areas in a manner which includes providing within said report a graphical representation of business and offering innovation factors relating to said client.

19. A computer-readable medium according to claim 17, wherein said program is further operable when executed to effect said identifying of said areas in a manner which includes providing within said report a graphical representation as to a plurality of predetermined factors of the perception by said client of a portion of said enterprise responsible for said client.

20. A computer-readable medium according to claim 17, wherein said program is further operable when executed to effect said identifying of said areas in a manner which includes providing within said report a graphical comparison for a plurality of predetermined factors of capacity for innovation by each of said client and a portion of said enterprise responsible for said client.

21. A computer-readable medium according to claim 17, wherein said program is further operable when executed to effect said identifying of said areas in a manner which includes providing within said report a graphical comparison for a plurality of predetermined factors of the extent to which digital technologies are used by each of said client and a portion of said enterprise responsible for said client.

22. A computer-readable medium according to claim 15, wherein said program is further operable when executed to effect said utilizing of said answers in a manner which includes identifying within said report a value proposition of said enterprise as viewed by said client.

23. A computer-readable medium according to claim 22, wherein said program is further operable when executed to effect said identifying of said value proposition in a manner which includes providing within said report a graphical representation of said value proposition.

24. A computer-readable medium according to claim 22, wherein said program is further operable when executed to effect said utilizing of said answers in a manner which includes identifying within said report areas currently appropriate for encouraging growth in the relationship between said enterprise and said client.

25. A computer-readable medium according to claim 24, wherein said program is further operable when executed to effect said identifying of said areas in a manner which includes providing within said report a graphical representation of said areas currently appropriate for encouraging growth.

26. A computer-readable medium according to claim 24, wherein said program is further operable when executed to effect said utilizing of said answers in a manner which includes identifying within said report areas of past growth in the relationship between said enterprise and said client.

27. A computer-readable medium according to claim 26, wherein said program is further operable when executed to effect said identifying of said areas of past growth in a manner which includes providing within said report a graphical representation of historical impediments to growth.

28. A computer-readable medium according to claim 26, wherein said program is further operable when executed to effect said identifying of said areas of past growth in a manner which includes providing within said report a graphical representation of historical impediments to profitability.
